(19) United States
(12) Patent Application Publication
(10) Pub. No.: US 2004/0266909 A1
(43) Pub. Date: Dec. 30, 2004

(54) Pigment type ink composition having superior gas fastness, and recording method and recorded matter by using the same

(75) Inventor: Hiroaki Segawa, Chiba-ken (JP)

Correspondence Address: Ladas & Parry, 26 West 61 Street, New York, NY, 10023, US

(73) Assignee: SEIKO EPSON CORPORATION

(21) Appl. No.: 10/753,098

(22) Filed: Jan. 7, 2004

(30) Foreign Application Priority Data
Jan. 14, 2003 (JP) 2003-006032

(51) Int. Cl. C03C 17/00; C09D 5/00

(52) U.S. Cl. 523/160; 523/161

(57) ABSTRACT

It is an object of this invention to provide a violet ink composition having excellent gas fastness by prescribing a type and amount of a resin to be added to the ink composition. The violet ink composition of this invention contains: a colorant; a dispersant; water; and an organic solvent, and the colorant is C.I. pigment violet 23 and the dispersant is water-soluble styrene-(meth)acrylic resin, and when the weight of the colorant is set as a reference (100%) in terms of solids, the content of the resin is 30 to 80 wt %.

### BACRGROUND OF THE INVENTION

1. Field of the Invention

This invention relates to an ink composition and a recording method and a recorded matter using such ink composition, more particularly, to an ink composition with excellent gas fastness and a recording method and a recorded matter using such ink composition.

2. Description of Prior Art

In recent years, in order to extend a range of color reproduction by an inkjet recording method, violet ink has been added to an ink set conventionally consisting of the three pigment inks: yellow ink (Y), magenta ink (M), and cyan ink (C)

Previously, violet color had been obtained by compositing magenta ink and cyan ink, but now it is known that a wide range of color reproduction can be achieved by having violet ink in the ink set.

Japanese Patent Laid-Open Publication 2000-351928 discloses a color inkjet ink set for color printing, wherein at least one ink from orange ink, green ink, or violet ink that respectively contain particular pigments, is used in addition to the above three pigment inks, Y, M, and C, to enable a wide range of color reproduction.

Pigment violet 23 is a useful pigment to be used for the violet ink in order to expand the color reproduction range. However, there is a drawback that the pigment violet 23 is highly susceptible to oxidation degradation compared to other pigments (for example, pigment blue 15, pigment red 202, pigment yellow 74).

Consequently, compared with an image formed with the conventional ink set having for example cyan ink and magenta ink, an image formed with the violet ink composition using the pigment violet 23, is easier to deteriorate by the oxidizing gases present in the air such as ozone, NOx, SOx, and H₂S. In short, such image has poor gas fastness resistance.

As described, violet color had been obtained by compositing magenta ink and cyan ink that have relatively good gas fastness. However, as for the violet ink, no studies have been done to improve its gas fastness.

Accordingly, there has been a need to develop a violet ink that can form images with excellent gas fastness without degrading the print appearance (e.g. bronzing fastness and glossiness).

This invention was made to improve the above shortcomings of the violet ink composition, and it is an object of this invention to provide a violet ink composition having excellent gas fastness, by using the pigment violet 23 without degrading the print appearance (e.g. bronzing fastness and glossiness)

### SUMMARY

The above object is achieved by an ink composition containing: a colorant; a dispersant; water; and an organic solvent, wherein the colorant is C.I. pigment violet 23 and the dispersant is water-soluble styrene-(meth)acrylic resin, and when the weight of the colorant is set as a reference (100%) in terms of solids, the content of the resin is 30 to 80 wt %.

With this violet ink composition, it is possible to form images with excellent gas fastness without degrading the print appearance (e.g. bronzing fastness and glossiness) on ink-jet paper.

### DESCRIPTION OF THE PREFERRED EMBODIMENTS

The violet ink composition of this invention is preferably used as a water-based ink composition containing a colorant, a dispersant, a penetrating agent, a water-soluble organic solvent, and water (preferably pure water).

(Colorant)

The colorant used in this invention is C.I. pigment violet 23 as described.

In a preferred embodiment of this invention, the mean particle diameter of the colorant is 200 nm or less, preferably about 50 to 150 nm.

With such colorant, it is possible to enhance glossiness and coloring ability.

In this invention, the amount of the colorant mixed in the violet ink composition may be selected as appropriate, but it is preferable for this amount to be 0.3 to 8.0 wt %, more preferably 1.0 to 5.0 wt % relative to the amount of the violet ink composition.

In a preferred embodiment, it is preferable for the colorant used in this invention to be added to the ink composition in the form of a pigment dispersion obtained by dispersing the colorant in a water-based solvent using a dispersant.

(Dispersant)

In the violet ink composition of this invention, a water-soluble styrene-(meth)acrylic resin is used as a dispersant, as described.

Examples of the water-soluble acrylic resin include styrene-acrylic acid resins such as: styrene-acrylic acid copolymers; styrene-methacrylic acid copolymers; styrene-acrylic acid-acrylic acid alkyl ester copolymers; styrene-methacrylic acid-acrylic acid alkyl ester copolymers; styrene-alpha-methylstyrene-acrylic acid copolymers; and styrene-alpha-methylstyrene-acrylic acid-acrylic acid alkyl ester copolymers, and salts thereof. In particular, it is preferable to use the styrene-acrylic acid copolymers or their salts. Note that such water-soluble acrylic resins may be used alone, or two or more types can be used together.

When the weight of the colorant is set as a reference (100 wt %) in terms of solids, the amount of water-soluble acrylic resin added is 30 to 80 wt % as described above. In particular, it is preferable for the added amount to be 30 to 60 wt % so that the water-soluble acrylic resin serves as a dispersant; the shelf life of printed matter can be improved with the enhancement of gas fastness; the image quality can be improved by inhibiting bronzing and controlling glossiness degradation; and fixation can be enhanced.

When the added amount of the water-soluble acrylic resin is less than 30 wt %, gas fastness and bronzing fastness degrade, and when 80 wt % is exceeded, glossiness degrades.

It is preferable that the acid value of the water-soluble acrylic resin be 50 to 250, more preferably, 70 to 200.

With this acid value, the reliability (such as storage stability and printing stability) of the ink can be improved.

It is preferable that a weight average molecular weight (hereinafter “Mw”) of the water-soluble acrylic resin be 1,000 to 100,000, more preferably 3,000 to 50,000, and most preferably 5,000 to 20,000. When the Mw is less than 1,000, the binder function and fixation of the ink may degrade, and when 100,000 is exceeded, the storage stability as well as the discharge stability of the ink may drop.

It is also possible to use a surfactant as a dispersant, together with the water-soluble acrylic resin. Examples of preferable surfactants include: anionic surfactants such as fatty acid salts, higher alkyl dicarboxylic acid salts, higher alcohol sulfuric acid ester salts, higher alkylsulfonic acid salts, condensation products of higher fatty acids and amino acids, sulfosuccinic acid ester salts, naphthenic acid salts, liquid fatty oil sulfuric acid ester salts, and alkylallylsulfonic acid salts; cationic surfactants such as fatty acid amine salts, quaternary ammonium salts, sulfonium salts, and phosphonium; and nonionic surfactants such as polyoxyethylene alkyl ethers, polyoxyethylene alkyl esters, sorbitan alkyl esters, and polyoxyethylenesorbitan alkyl esters.

These surfactants perform a surface-activating function by being added to the ink composition.

(Penetrating Agent)

In a preferred embodiment of this invention, the ink composition may contain a penetration promoter in order to enhance the penetrability of the ink composition by increasing the wettability relative to a recording medium. Examples of the penetration promoter include: all kinds of surfactants such as cationic surfactant, anionic surfactant, and nonionic surfactant; alcohols such as methanol, ethanol, and isopropyl alcohol; polyhydric alcohol lower alkyl ethers such as ethylene glycol monomethyl ether, diethylene glycol monoethyl ether, diethylene glycol monobutyl ether, triethylene glycol monobutyl ether, propylene glycol monobutyl ether, and diols such as 1,2-pentanediol and 1,2-hexanediol. These penetration promoters can either be used alone, or two or more of the promoters can be used together. In particular, it is preferable for diols such as 1,2-hexanediol to be used.

It is preferable that the amount of the penetration promoter in the ink composition be about 1 to 15 wt %, more preferably about 2 to 10 wt %.

It is also possible to use, as the penetration promoter, an acetylenic glycol type compound represented by the following general formula (1) or a polysiloxane type compound represented by the following general formula (2). A commercially available product can be used as an acetylenic glycol type compound. Examples of such a product include: Surfynol 82, 440, 465 and STG (product names; all available from Air Products and Chemicals, Inc.); Olfine Y and Olfine E1010 (product names; both available from Nisshin Chemical Industry Co., Ltd.). These products can either be used alone, or two or more of these can be used together. As for the polysiloxane type compound, for example, silicon surfactants BYK-345, BYK-346, BYK-347, or BYK-348 (all available from BYK-Chemie Japan) can be used.

It is preferable that the amount of the acetylene glycol type compound and/or the polysiloxane type compound contained in the ink be 0.1 to 5 wt %, more preferably, 0.5 to 2 wt %.

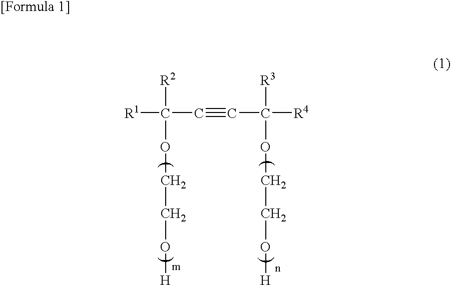

(In this formula, 0≦m+n≦50, and each of R¹ to R⁴ independently represents an alkyl group having 1 to 6 carbons.)

[Formula 2]

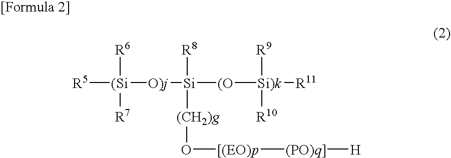

(In this formula, each of R⁵ to R¹¹ independently represents a C₁₋₆alkyl group; J, k and g are all independently integer numbers equal to 1 or greater; EO represents an ethylene oxy group; PO represents a propylene oxy group; p and q are both integer numbers equal to 0 or greater but p+q makes an integer number equal to 1 or greater; and EO and PO may be random or block, regardless of the order in the square brackets [ ].)

(Water and Water-Soluble Organic Solvents)

The ink composition of this invention contains water and water-soluble organic solvents as its basic solvents. Examples of the water-soluble organic solvent include: glycerin; ethylene glycol; diethylene glycol; triethylene glycol; tetraethylene glycol; propylene glycol; dipropylene glycol; tripropylene glycol; polyethylene glycol with a Mw of 2,000 or less; 1,3-propylene glycol; isopropylene glycol; isobutylene glycol; 1,4-butanediol; 1,3-butanediol; 1,5-pentanediol; 1,6-hexanediol; meso-erythritol; and penta erythritol. Among these, it is preferable for glycerin to be used.

These water-soluble organic solvents preferably enhance the solubility of other components contained in the ink composition, improve the penetrability of the ink to a recording medium such as a paper, and effectively prevent nozzle clogging

The amount of the water-soluble organic solvents added to the ink composition may be selected as appropriate, but it is preferable for the amount to be about 1 to 30 wt %, more preferably, about 5 to 15 wt %.

(Other Ink Components)

In the ink composition of this invention, furthermore, such additives as a nozzle anti-clogging agent, preservatives, antioxidants, electrical conductivity adjusting agents, pH regulators, viscosity adjusting agents, surface tension adjusting agents, and oxygen absorbents can be used.

Examples of preservatives or fungicides include: sodium benzonate; sodium pentachlorophenol; 2-pyridine thiol-1-oxide; sodium sorbate; sodium dehydroacetate; and 1,2-dibenzine thiazoline-3-one (Proxel CRL, Proxel BND, Proxel GXL, Proxel XL-2, and Proxel TN, all are available from Avecia Limited).

Examples of the pH regulators or dissolution accelerators include: amines and transformations thereof such as diethanolamine, triethanolamine, propanolamine, and morpholine; inorganic salts such as potassium hydroxide, sodium hydroxide, and lithium hydroxide; ammonium hydroxide; quaternary ammonium hydroxide (tetramethylammonium, etc.); carbonates such as potassium carbonate, sodium carbonate, and lithium carbonate; phosphate; ureas such as N-methyl-2-pyrrolidone, urea, thiourea, and tetramethylurea; alohanates such as alohanate and methyl alohanate; biurets such as biuret, dimethyl biuret, tetramethyl biuret; and L-ascorbic acid, and salts thereof.

The ink composition of this invention may contain antioxidants and UV absorbing agents, for example Tinuvin 328, 900, 1130, 384, 292, 123, 144, 622, 770 and 292 available from Ciba-Geigy Japan Limited; Irgacor 252 and 153; Irganox 1010, 1076, and 1035; and MD1024 and lanthamide oxides, etc.

(Manufacturing Method of the Ink Composition)

The ink composition of this invention may be prepared, for example, by dispersing and mixing the aforementioned components using an appropriate method. Preferably, at first, a pigment and a dispersant are mixed with an appropriate disperser (e.g., ball mill, sand mill, atrighter, roll mill, agitator mill, Henshell mixer, colloid mill, supersonic homogenizer, jet mill, ong mill) and made into a homogeneous pigment dispersed liquid. At the same time, components other than the pigment and dispersant are mixed and made into an ink solvent. Then, the pigment dispersed liquid is dripped into the ink solvent while being agitated.

Optionally, saccharides, pH regulators, preservatives, fungicides, and the like may be added and dissolved thoroughly into the ink solution in order to adjust the ink solution. After being fully agitated, the ink solution is subjected to filtering to remove the large coarse particles and foreign matter which can cause clogging. Thus, an ink composition is obtained.

(Recording Method)

This invention provides a recording method for carrying out printing by attaching an ink composition to a recording medium, wherein the aforementioned violet ink composition is used. Examples of the recording method include ink-jet recording method, recording method using writing instruments such as pens, and various other printing methods.

In particular, this invention provides an ink-jet recording method for carrying out printing by discharging and attaching ink composition droplets onto a recording medium, with the aforementioned violet ink composition being used as the ink composition.

Since the recording method of this invention uses the violet ink composition constituted as above, when a dedicated inkjet medium is used, it is possible to form print images with good gas fastness and excellent print appearance (such as bronzing fastness and glossiness).

(Recorded Matter)

This invention provides a recorded matter printed by the above recording method.

Since the recorded matter of this invention is formed by using the violet ink composition constituted as above, when a dedicated inkjet medium is used, it is possible to form print images with good gas fastness and excellent print appearance (such as bronzing fastness, and glossiness).

### EXAMPLES

This invention is now explained in detail with reference to the following examples. These examples, however, shall not limit the scope of this invention in any way. Note that percentages are all weight percentages unless otherwise indicated in the examples or comparative examples.

### (1) Example 1

A pigment ink composition having the components shown below was prepared based on the following procedure. 10.0 wt % of C.I. pigment violet 23 as a colorant, 20.0 wt % of ammonium salt of a styrene-acrylic acid copolymer (Mw=10000, acid value=122, polymer component=15%) as a dispersant, and 70.0 wt % of water as a solvent, were thoroughly mixed, and then this mixture was dispersed in a sand mill (manufactured by Yasukawa Seisakusyo) together with glass beads (diameter=1.7 mm; 1.5 times the weight of the mixture) until the mean particle diameter of the colorant was 200 nm or less. After dispersion, the glass beads were removed, and finally a pigment dispersed liquid was obtained.

In addition to the pigment dispersed liquid obtained, a vehicle was prepared having components differing from the pigment dispersed liquid (see below). This vehicle was gradually dripped into the pigment dispersed liquid, and this mixture was thoroughly stirred, and then, subjected to filtering by using a membrane filter having a pore size of 5 μm. Finally, an aqueous pigment ink composition for ink-jet recording was obtained. The components of the aqueous pigment ink composition are as follows.

| | |
|---|---|
| Pigment dispersed liquid | 25.0% |
| BYK347 | 0.5% |
| 1,2-hexanediol | 10.0% |
| Glycerin | 14.0% |
| Triethanolamine | 1.0% |
| Pure water | Remainder |

### (2) Example 2

A pigment ink composition having the components shown below was prepared based on the following procedure. 10.0 wt % of C.I. pigment violet 23 as a colorant, 40.0 wt % of ammonium salt of a styrene-acrylic acid copolymer (Mw=10000, acid value=122, polymer component=15%) as a dispersant, and 50.0 wt % of water as a solvent, were thoroughly mixed. Then, this mixture was dispersed in a sand mill (manufactured by Yasukawa Seisakusyo) together with glass beads (diameter=1.7 mm; 1.5 times the weight of the mixture) until the mean particle diameter of the colorant was 200 nm or less. After dispersion, the glass beads were removed, and finally a pigment dispersed liquid was obtained.

In addition to the pigment dispersed liquid obtained, a vehicle was prepared having components differing from the pigment dispersed liquid (see below). This vehicle was gradually dripped into the pigment dispersed liquid. This mixture was thoroughly stirred, and then, subjected to filtering by using a membrane filter having a pore size of 5 μm. Finally, an aqueous pigment ink composition for ink-jet recording was obtained. The components of the aqueous pigment ink composition obtained are as follows.

| | |
|---|---|
| Pigment dispersed liquid | 25.0% |
| BYK347 | 0.5% |
| 1,2-hexanediol | 10.0% |
| Glycerin | 12.0% |
| Triethanolamine | 1.0% |
| Pure water | Remainder |

### (3) Example 3

A pigment ink composition having the components shown below was prepared based on the following procedure. 10.0 wt % of C.I. pigment violet 23 as a colorant, 53.3 wt % of ammonium salt of a styrene-acrylic acid copolymer (Mw=10000, acid value=122, polymer component=15%) as a dispersant, and 36.7 wt % of water as a solvent, were thoroughly mixed. Then this mixture was dispersed in a sand mill (manufactured by Yasukawa Seisakusyo) together with glass beads (diameter=1.7 mm; 1.5 times the weight of the mixture) until the mean particle diameter of the colorant was 200 nm or less. After dispersion, the glass beads were removed, and finally a pigment dispersed liquid was obtained.

In addition to the pigment dispersed liquid obtained, a vehicle was prepared having components differing from the pigment dispersed liquid (see below). This vehicle was gradually dripped into the pigment dispersed liquid, and this mixture was thoroughly stirred, and then, subjected to filtering by using a membrane filter having a pore size of 5 μm. Finally, an aqueous pigment ink composition for ink-jet recording was obtained. The components of the aqueous pigment ink composition are as follows.

| | |
|---|---|
| Pigment dispersed liquid | 25.0% |
| BYK347 | 0.5% |
| 1,2-hexanediol | 10.0% |
| Glycerin | 12.0% |
| Triethanolamine | 1.0% |
| Pure water | Remainder |

### (4) Comparative Example 1

A pigment ink composition having the components shown below was prepared based on the following procedure. 10.0 wt % of C.I. pigment violet 23 as a colorant, 13.3 wt % of ammonium salt of a styrene-acrylic acid copolymer (Mw 10000, acid value=122, polymer component=15%) as a dispersant, and 76.7 wt % of water as a solvent, were thoroughly mixed. Then this mixture was dispersed in a sand mill (manufactured by Yasukawa Seisakusyo) together with glass beads (diameter=1.7 mm; 1.5 times the weight of the mixture) until the mean particle diameter of the colorant was 200 nm or less. After dispersion, the glass beads were removed, and finally a pigment dispersed liquid was obtained.

In addition to the pigment dispersed liquid obtained, a vehicle was prepared having components differing from the pigment dispersed liquid (see below). This vehicle was gradually dripped into the pigment dispersed liquid, and this mixture was thoroughly stirred, and then, subjected to filtering by using a membrane filter having a pore size of 5 μm. Finally, an aqueous pigment ink composition for ink-jet recording was obtained. The components of the aqueous pigment ink composition are as follows.

| | |
|---|---|
| Pigment dispersed liquid | 25.0% |
| BYK347 | 0.5% |
| 1,2-hexanediol | 10.0% |
| Glycerin | 14.0% |
| Triethanolamine | 1.0% |
| Pure water | Remainder |

### (5) Comparative example 2

### Example 1

A pigment ink composition having the components shown below was prepared based on the following procedure. 10.0 wt % of C.I. pigment violet 23 as a colorant, 66.7 wt % of ammonium salt of a styrene-acrylic acid copolymer (Mw=10000, acid value=122, polymer component=15%) as a dispersant, and 23.3 wt % of water as a solvent, were thoroughly mixed, and then this mixture was dispersed in a sand mill (manufactured by Yasukawa Seisakusyo) together with glass beads (diameter=1.7 mm; 1.5 times the weight of the mixture) until the mean particle diameter of the colorant was 200 nm or less. After dispersion, the glass beads were removed, and finally a pigment dispersed liquid was obtained.

In addition to the pigment dispersed liquid obtained, a vehicle was prepared having components differing from the pigment dispersed liquid (see below). This vehicle was gradually dripped into the pigment dispersed liquid, and this mixture was thoroughly stirred, and then, subjected to filtering by using a membrane filter have a pore size of 5 μm. Finally, an aqueous pigment ink composition for ink-jet recording was obtained. The components of the aqueous pigment ink composition are as follows.

| | |
|---|---|
| Pigment dispersed liquid | 25.0% |
| BYK347 | 0.5% |
| 1,2-hexanediol | 10.0% |
| Glycerin | 10.0% |
| Triethanolamine | 1.0% |
| Pure water | Remainder |

(Test 1) Gas Fastness Evaluation

Gas fastness evaluations were made as follows using the violet ink composition obtained with the examples 1 to 3 and the comparative examples 1 and 2.

Printing was carried out on PM photo paper [inkjet paper (manufactured by Seiko Epson Corporation)] using an ink-jet printer [PM-920C (manufactured by Seiko Epson Corporation)], while adjusting duty so that the optical density values (OD values) would be in the range of 0.9 to 1.1.

The printed matters obtained were exposed to ozone for three hours using Ozone Weather Meter OMS-H (product name; manufactured by Suga Test Instrument Co. Ltd.) under the condition that ozone density is 200 ppm, the temperature is 24° C., and relative humidity is 60%.

After exposure, OD values of the respective printed matters were measured with a densitometer (Spectrolino; manufactured by Gretag), and the residual optical densities (RODs) were obtained by using the following formula.

ROD(%)=(D/Dₒ)×100

(Measuring conditions: Filter is red; light source is D50; and visibility angle is 2 degrees)

In the above formula, D represents an OD value after the exposure and Dₒ represents an OD value before exposure.

The evaluation criteria used are as follows.

Evaluation A: 80%≦ROD

B: 70%≦ROD<80%

C: ROD<70%

(Test 2) Bronzing Fastness Evaluation

Bronzing fastness evaluations were made using the violet ink compositions obtained with the examples 1 to 3 and the comparative examples 1 and 2. Printing was carried out on PM photo paper [inkjet paper (manufactured by Seiko Epson Corporation)] using an inkjet printer [PM-920C (manufactured by Seiko Epson Corporation)] at 20, 40, 60, 80 and 100% print duties. The bronzing fastness of each ink composition was evaluated by visually observing the samples from various angles. The bronzing fastness evaluation criteria are as follows.

Evaluation A: No bronzing is observed or bronzing is almost unnoticeable, when printed at any print duty.

B: Bronzing observed when printed at one or two duties.

C: Bronzing observed when printed at three or more print duties.

(Test 3) Glossiness Evaluation

Glossiness evaluations were made using the violet ink compositions obtained with the examples 1 to 3 and the comparative examples 1 and 2. Printing was carried out on PM photo papers [inkjet papers (manufactured by Seiko Epson Corporation)] using an inkjet printer [PM-920C (manufactured by Seiko Epson Corporation)] at 20, 40, 60, 80 and 100% print duties. The glossiness of each ink composition was evaluated by visually observing the printed samples. The glossiness evaluation criteria are as follows.

Evaluation A: When a fluorescent light is shone on the printed side of the paper, the light is clearly reflected.

B: When a fluorescent light is shone on the printed side of the paper, the clarity of the reflected light is slightly low.

C: When a fluorescent light is shone on the printed side of the paper, the reflected light is dull and the clarity is poor.

(Test 4) Light Fastness Evaluation

Light fastness evaluations were made using the violet ink compositions obtained with the examples 1 to 3 and the comparative examples 1 and 2. Printing was carried out on PM photo papers [inkjet papers (manufactured by Seiko Epson Corporation)] using an inkjet printer [PM-920C (manufactured by Seiko Epson Corporation)] while adjusting duty so that OD values would be in the range of 0.9 to 1.1. The printed matters obtained were subjected to an exposure test for 1200 hours using Xenon Weather Meter (manufactured by Atlas) under the conditions that the temperature is 24° C. and the relative humidity is 60%.

After exposure, OD values of the respective printed matters were measured with a densitometer (Spectrolino; manufactured by Gretag), and RODs were obtained by using the following formula.

ROD(%)=(D/Dₒ)×100

(Measurement conditions: Filter is red; light source is D50; and visibility angle is 2 degrees)

Note that, in the above formula, D represents an OD value after the exposure and D₀ represents an OD before exposure. The evaluation criteria used are as follows.

Evaluation A: 90%≦ROD

B: 70%≦ROD<90%

C: ROD<70%

TABLE 1

| | | Test 1 | Test 2 | | Test 4 |
|---|---|---|---|---|---|
| | | (Gas | (Bronzing | Test 3 | (Light |
| Violet ink | B/P | fastness) | fastness) | (Glossiness) | fastness) |
| Comparative | 20 | C | B | A | A |
| example 1 | | | | | |
| Example 1 | 30 | A | A | A | A |
| Example 2 | 60 | A | A | A | A |
| Example 3 | 80 | A | A | A | A |
| Comparative | 100 | A | A | C | A |
| example 2 | | | | | |

B/P: dispersant/colorant

We claim:

1. An ink composition containing:
a colorant;
a dispersant;
water; and
an organic solvent,
wherein the colorant is C.I. pigment violet 23 and the dispersant is water-soluble styrene-(meth)acrylic resin, and when the weight of the colorant is set as a reference (100%) in terms of solids, the content of the resin is 30 to 80 wt %.

2. The ink composition according to claim 1 wherein the acid value of the water-soluble styrene-(meth)acrylic resin is 50 to 250.

3. The ink composition according to claim 1 or 2 wherein the content of the colorant is 0.3 to 8 wt %.

4. The ink composition according to claim 1 wherein a mean particle diameter of the colorant is 200 nm or less.

5. The ink composition according to claim 1 used in an ink-jet recording method.

6. A recording method for carrying out printing by attaching an ink composition onto a recording medium, wherein the ink composition according to claim 1 is used as the ink composition.

7. A recording method for carrying out printing by discharging ink composition droplets and making the droplets attached to a recording medium, wherein the ink composition according to claim 1 is used as the ink composition.

8. A recorded matter printed by the method according to claim 6.

9. A recorded matter printed by the method according to claim 7.
